(19) United States
(12) Patent Application Publication
(10) Pub. No.: US 2007/0052195 A1
(43) Pub. Date: Mar. 8, 2007

(54) Light truck support lift

(76) Inventor: Hector Collazo, Viera, FL (US)

Correspondence Address: Hector Collazo, 8517 Mizell Drive, Viera, FL, 32940, US

(21) Appl. No.: 11/221,336

(22) Filed: Sep. 7, 2005

(51) Int. Cl. B60G 11/00; B60G 17/00

(52) U.S. Cl. 280/124.175; 280/6.157

(57) ABSTRACT

The invention relates to a novel spring support system for light trucks, which is adjustable to elevate the rear of the light truck to what's needed, depending on the demand of the consumer, a body member with a central portion with two adjustable bars, a top portion with a round steel cylinder in between both bars, bolts to the body frame for strong support, two adjustable bars comes down with the adjusting mechanism and bolts to the leaf springs of the vehicle, made out of steel material or sheet metal.

### BACKGROUND AND SUMMARY OF THE INVENTION

1. This invention relates to a novel lifter mechanism system specifically made to elevate the bed of a light truck or vehicle when the vehicle is sagging from the rear due to over load materials or due to installing a heavy topper to carry tools or machineries. One reason this devise was invented is to eliminate the sagging problem that exists in light trucks and also it provides an alternate mechanism that adjusts the rear of the vehicle without replacing the part. It is also known that this mechanism helps to maintain the light trucks balance. It was observed that the light truck operates better and increases the performance of the vehicle. The result of this mechanism prevents the vehicle from sagging down and the air flowing underneath the vehicle during driving short or long distances causing the vehicle to slow down a little and putting more pressure on the motor due to the amount of air pressure going under the vehicle and load carrying. The invention will eliminate this problem allowing the vehicle to ride proficient and normal on the streets of our community.

2. The unique part of this invention is that the consumer will have a devise that can be adjusted and not replaced. This invention is easy to install and can be adjusted to different sizes to regulate the elevation of the vehicle. In addition, it is a devise that is easy to develop, manufacture and economical to the consumer.

3. The Light Truck Support Lift System as claimed in 1, wherein said adjustable bars exist, will be secured with two threaded bolts in between for the safety of the consumer.

4. The Light Truck Support Lift System as claimed in 1, wherein said first mounting refers to the connection of the frame of the vehicle.

5. The Light Truck Support Lift System as claimed in 3, wherein the second mounting connects to the leaf springs of the vehicle.

6. The Light Truck Support Lift System as claimed in 1, wherein said cylinder will placed in between the bars in the upper section to avoid friction between the members and more stable.

7. The Light Truck Support Lift System as claimed in 6, wherein said cylinder is round and in the form of steel, with a half-inch hole through the cylinder to secure the part between both members.

8. The Light Truck Support Lift System is for supporting one end of said body member, which connects the leaf spring suspension system, compromising of five body members;

First, mounting will consist of three upper body members, the two straight bar members and a round steel cylinder in the center of both bars, which is bolted together to the frame of the vehicle by a five inches threaded bolt grade #5;

Second, mounting elements will consist of two lower straight bars, with a quarter inch bend in both sides, double F shape, approximately seven inches in length so the upper bar easily can slide inside without causing interference with the bracket and avoiding any side movement for more stability, bolted with two one and quarter inch threaded bolts, in between each member, totally of four bolts for both bars and follows down to the connectivity to the said leaf spring suspension with a five inch threaded bolt.

### BRIEF DESCRIPTION OF THE DRAWING

FIG. 1 is a side view of invention 2 and 4 showing the invention's connectivity from the side on the vehicle frame 8 and leaf springs 12, in the upper area, there is bracket 6 is riveted 10 four times to the frame 8; the invention has one additional adjustable holes 28 so it can be adjusted to the appropriate adjustment if needed, 4 inserts into 2 supported with two central bolts 14 and 16 for safety;

FIG. 2 is rear view of all elements together, partly in sections, and how it connects with one another and the vehicle frame 8 and leaf springs 12 shown in FIG. 2; whereas it bolts on the upper bracket 6, bolted 24 through the bar and cylinder 22 tighten with a washer 25 and nut 26 inside the frame 8; supported in the center with bolts 14, 16, 18 and 20; coming down to the lower end bolted 30 through the leaf suspension bushing 12 with a washer 32 and tighten with a nut 34;

FIG. 3 is the top view of the invention 2, and 4 discussed on FIG. 1 illustrating the cylinder 22 on the upper portion and how is connected to the bracket 6 and frame 8, a threaded bolt 24 going through the adjustable bars 4, cylinder, frame and tighten with a washer 25 and nut 26;

FIG. 4 is the invention in five parts, the two upper members of the bars 4 and the cylinder 22 in between; the two lower members known in the description as 2 in FIG. 1;

FIG. 5 is the side view of the upper member 4 and the lower member 2 discussed in FIG. 4;

FIG. 6 is the three-sided view composed of upper portion 4, with a round cylinder 22, and lower portion 2 demonstrated in FIG. 4.

### DETAILED DESCRIPTION OF THE INVENTION

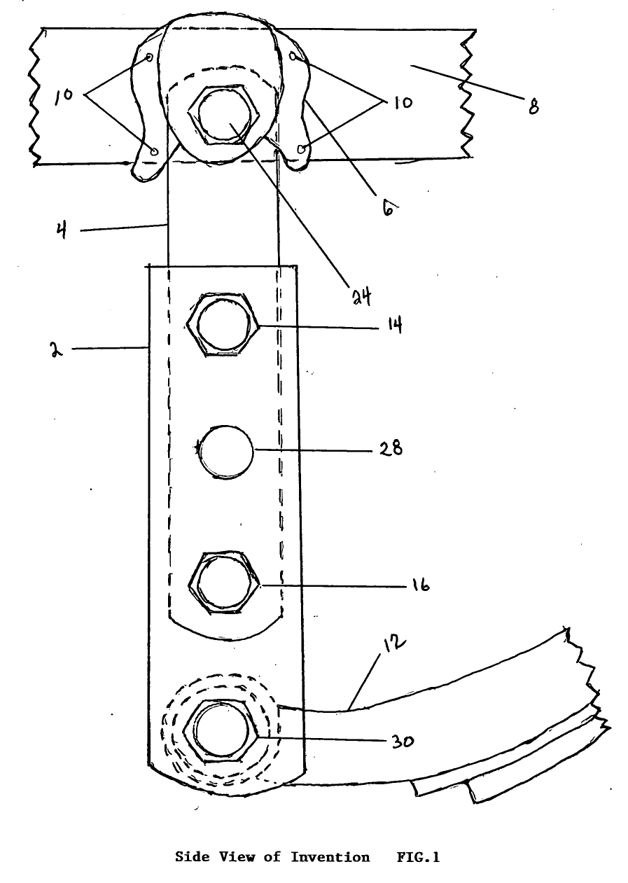

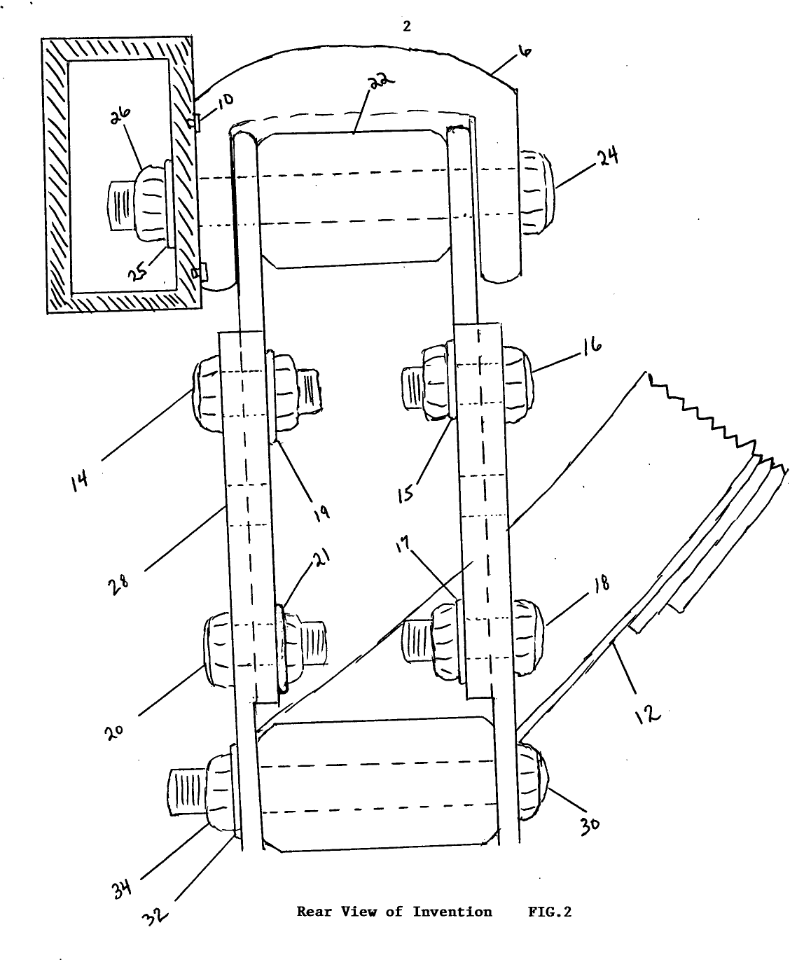

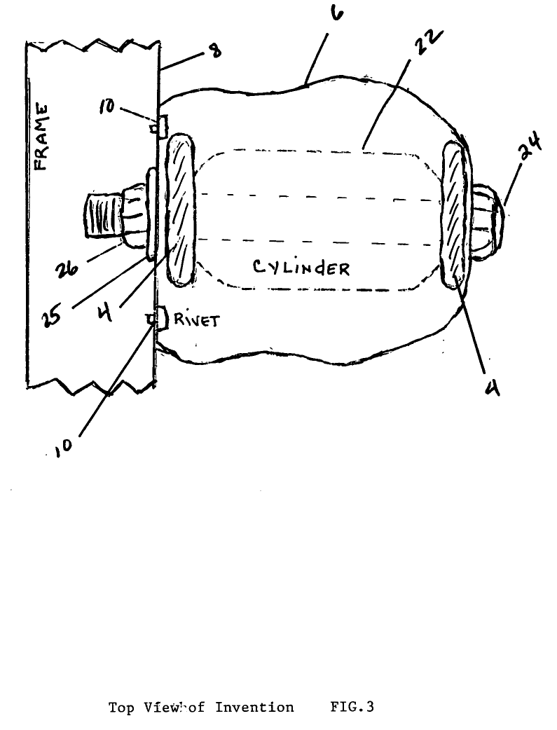

Referring to FIGS. 1 and 2, Light Truck Support Lift System, it connects through the bracket 6, at one end, bracket is riveted 10 to the frame 8, whereas upper portion of the invention bars 4 inserts into the lower portion 2, there are two bolts connecting to the members; and coming down to bolt 30 shows the connectivity to the leaf springs on the lower portion 2 of the invention; whereas bolt 24 illustrates the connectivity on the upper portion of the invention and through the bracket 6 which is riveted 10 to the frame 8; in the upper section of 4 is a small cylinder 22, FIG. 3 which assists the bar members to hold more secured and tightened with a threaded bolt 24, a washer 25 and nut 26; whereas both bar members are secured with four #5 bolts 14, 16, 18 and 20 to have a more stable devise with a strong and safe support system installed in a vehicle with an improved adjustable bars to eliminate a vehicle from sagging from the rear when carrying tools or extra weight. This apparatus will aid the suspension system to control the rear axle from dropping with pressure causing an uncomfortable ride and avoiding putting more pressure to the rear system.

It is understood that the Light Truck Support Lift System 2 and 4 will be made in two straight bars of steel metal having a round cylinder in between 22, whereas the upper member slides into lower member 2, bolted on 24 and having a central cylinder 22 on the upper section will provide a stiff support to the upper member 4 to avoid any movement from occurring and causing damage on the vehicle.

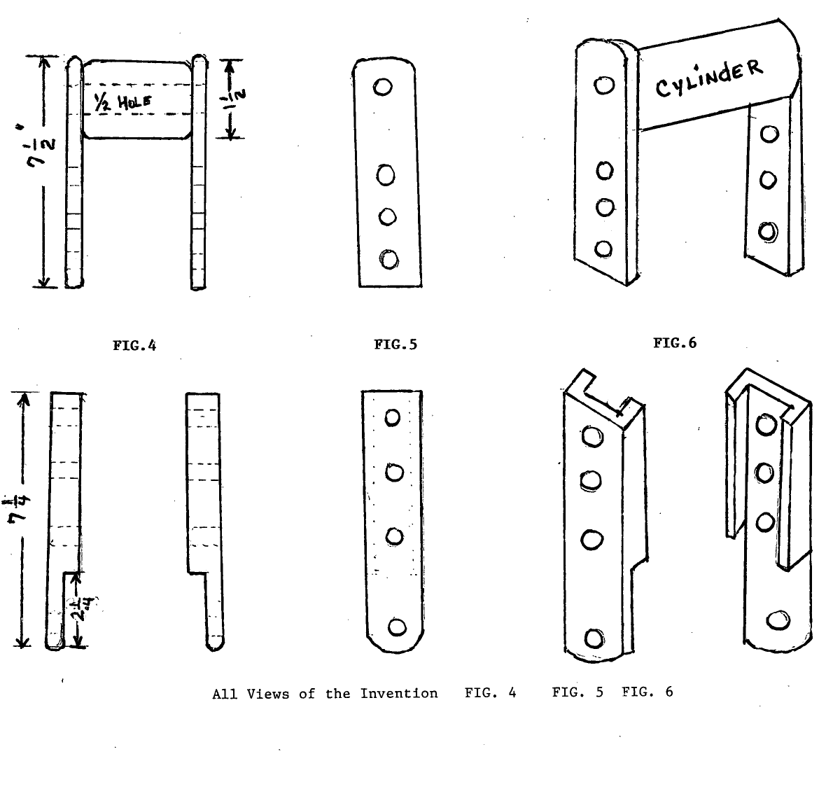

The method of making the Light Truck Support Lift System 2, 4, and 22 is best understood by referring to FIG. 4, 5, and 6.; FIG. 4, 5, and 6 has the appropriate measurements to manufacture the invention.

While the specifics embodiment of the apparatus has been described and the method of construction. It is understood that the present invention may be varied within the scope of the appended claims without departing from the spirit and main idea of the invention.

I claim:

1. A Light Truck Support Lift System for mounting of a suspension spring to a vehicle frame, compromising of five body members;
first mounting means three members in the upper section compromising two straight bars parallel to each other with a round cylinder in between to avoid friction or movement between each member, bolted to the frame in the upper area of the suspension system of said vehicle;
second mounting will consist of two straight bars, with an “F” shape for stability; which it will bolt into the leaf spring of the suspension system at bottom; whereas the two upper bars will insert into the two lower members and it will be bolted together with two bolts per member in two areas between the top and bottom bars to lock the devise in place and secure the proper adjustment, it is understood that the upper member slides inside the lower member to adjust the suspension to what is necessary, wherein the adjustment will be determine by the type of vehicle and how much space is available for adjustment.

2. The Light Truck Support Lift System as claimed in 1, wherein said devise is a straight bar comprising of two sections, whereas one slides inside of the other one for extension purposes and proper adjustment, made out of steel to provide a safety and strong support lift devise to the vehicle.

3. The Light Truck Support Lift System as claimed in 2, wherein said top portion inserts into the bottom portion, are bolted together with each other with 2 bolts in each bar comprised of 4 bolts for a set of bars.

4. The Light Truck Support Lift System as claimed in 3, wherein said second mounting means connects said lift to the frame and leaf springs of said vehicle.

5. The Light Truck Support Lift System as claimed in 4, wherein said upper top support will have a round cylinder form of steel. This cylinder will hold both bar members in position avoiding any friction between the members.
